(19) United States
(12) Patent Application Publication
(10) Pub. No.: US 2003/0044573 A1
(43) Pub. Date: Mar. 6, 2003

(54) Pseudo-apertured fibrous structure

(76) Inventors: David Mark Rasch, Cincinnati, OH (US); Lois Jean Forde-Kohler, Cincinnati, OH (US); Ward William Ostendorf, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/945,996

(22) Filed: Sep. 4, 2001

(51) Int. Cl. B32B 3/10; D04H 1/00; D04H 3/00

(52) U.S. Cl. 428/131; 428/218; 442/409; 264/504; 264/555

(57) ABSTRACT

A multi-density fibrous structure comprising a plurality of discrete pseudo-apertures disposed therein. The pseudo-apertures have individual areas of at least about 3 square millimeters and a basis weight from about 0.1 to about 5 gram per square meter. The fibrous structure can have from about 9,000 to about 90,000 pseudo-apertures per square meter.

### FIELD OF THE INVENTION

The present invention is related to flexible fibrous structures. More particularly, this invention is concerned with multi-density and/or multi-basis weight fibrous structures having a plurality of pseudo-apertures therein.

### BACKGROUND OF THE INVENTION

Through-air-dried fibrous structures, such as, for example, paper webs, and equipment for making same, are known and described in several commonly assigned U.S. Patents, the disclosures of which are incorporated hereinby reference: U.S Pat. No. 4,514,345, issued Apr. 30, 1985 to Johnson et al.; U.S. Pat. No. 4,528,239, issued Jul. 9, 1985 to Trokhan; U.S. Pat. No. 4,529,480 issued Jul. 16, 1985 to Trokhan; U.S. Pat. No. 4,637,859 issued Jan. 20, 1987 to Trokhan; U.S. Pat. No. 5,098,522, issued Mar. 24, 1992 to Smurkoski, et al.; U.S. Pat. No. 5,245,025 issued Sep. 14, 1993 to Trokhan et al.; U.S. Pat. No. 5,260,171, issued Nov. 9, 1993 to Smurkoski et al.; U.S. Pat. No. 5,275,700, issued Jan. 4, 1994 to Trokhan; U.S. Pat. No. 5,328,565, issued Jul. 12, 1994 to Rasch et al.; U.S. Pat. No. 5,334,289, issued Aug. 2, 1994 to Troikhan et al.; U.S. Pat. No. 5,431,786, issued Jul. 11, 1995 to Rasch et al; U.S. Pat. No. 5,496,624, issued Mar. 5, 1996 to Stelljes. Jr. et al.; U.S. Pat. No. 5,500,277, issued Mar. 19, 1996 to Trokhan et al.; U.S. Pat. No. 5,514,523, issued May 7, 1996 to Trokhan et al.; U.S. Pat. No. 5,527,428, issued Jun. 18, 1996 to Trokhan et al.; U.S. Pat. No. 5.554,467, issued Sep. 10, 1996, to Trokhan et al.; U.S. Pat. No. 5,566,724, issued Oct. 22, 1996 to Trokhan et al.; U.S. Pat. No. 5,624,790, issued Apr. 29, 1997 to Trokhan et al.; U.S. Pat. No. 5,628,876 issued May 13, 1997 to Ayers et al.; U.S. Pat. No. 5,679,222 issued Oct. 21, 1997 to Rasch et al.; U.S. Pat. No. 5,714,041 issued Feb. 3, 1998 to Ayers et al., U.S. Pat. No. 5,900,122 issued May 4, 1999 to Huston; and U.S. Pat. No. 5,948,210 issued Sep. 7, 1999 to Huston.

In papermaking belts of prior art a framework that may be continuous, semi-continuous, comprise a plurality of discrete protuberances, or any combination thereof, is joined to a fluid-permeable reinforcing element (such as, for example, a woven structure, or a felt). The framework extends outwardly from the reinforcing element to form a web-side of the belt (i. e., the surface upon which the web is disposed during a papermaking process), a backside opposite to the web-side, and deflection conduits extending therebetween. The deflection conduits provide spaces into which papermaking fibers deflect under application of a pressure differential during a papermaking process.

Papers produced on such molding members, disclosed in the aforementioned patents, are generally characterized by having at least two regions having differential intensive properties, most typically density and/or basis weight. For example, papers made using the belts having a continuous framework and a plurality of discrete deflection conduits dispersed therethrough comprise a continuous high-density network region and a plurality of discrete low-density pillows (or domes), dispersed throughout, separated by, and extending from the network region. The continuous high-density network region is designed primarily to provide strength, while the plurality of the low-density pillows is designed primarily to provide softness and absorbency. Such belts have been used to produce commercially successful products, such as, for example, Bounty® paper towels, Charmin® toilet tissue, and Charmin Ultra® toilet tissue, all produced and sold by the instant assignee. Commonly assigned U.S. Pat. Nos. 5,227,761 (Dean Van Phan et al., issued Jan. 11, 1994); U.S. Pat. No. 5,534,326 (Trokhan et al., issued Jul. 9, 1996); and U.S. Pat. No. 5,820,730 (5,820,730, Dean Van Phan et al., issued Oct. 13, 1998) describe a cellulosic fibrous structures having two or more regions distinguished from one another by at least one of their respective intensive properties.

The present invention provides a novel multi-density and/or multi-basis weight fibrous structure having a plurality of discrete pseudo-apertures therein. The present invention also provides a process for making such pseudo-apertured fibrous structure. The pseudo-apertured structure of the present invention can be used a variety of consumer disposable products, such as, for example, disposable filters, as disclosed in a co-pending, commonly assigned, and incorporated herein by reference U.S. patent application Ser. No. _____, titled “Multi-Ply Filter” and filed on the filing date of the present application; diapers, items of feminine protection, medical devices, and others.

### SUMMARY OF THE INVENTION

A single-ply fibrous structure of the present invention comprises a plurality of discrete pseudo-apertures disposed therein The pseudo-apertures can, but do not have to, be disposed in a non-random and repeating pattern. The pseudo-apertures have individual areas of at least about 3 and more specifically at least 6, square millimeters. and a basis weight from about 0.1 gram per square meter to about 5 gram per square meter. The fibrous structure has from about 5,000 to about 90,000, and more specifically from about 9,000 to about 35,000 pseudo-apertures per square meter. The individual areas of the pseudo-apertures can have a major axis and a minor axis perpendicular to the major axis, the major being from about 1 times to about 100 times, and more specifically from about 5 times to about 50 times, greater than the minor axis.

The pseudo-apertured fibrous structure of the present invention further comprises a first plurality of micro-regions (or first region(s)) having first properties, and a second plurality of micro-regions (or second region(s)), having second properties. The first properties are different, in at least one respect, from the second properties. Such properties include, without limitation, density, basis weight, and opacity. The first region is substantially macroscopically-monoplanar and defines an X-Y plane, the second region outwardly extends from the first region in a direction perpendicular to the first plane.

In one embodiment, the first region has a relatively high density, and the second region comprises a plurality of fibrous pillows having a density lower than the density of the first region. In another embodiment, the first and second pluralities of micro-regions can differentiate by their respective basis weight, For example, the second plurality of micro-regions can have a basis weight that is greater than that of the first plurality of micro-regions. All such embodiments are included in the scope of the present invention.

In one embodiment, the fibrous structure comprises a substantially continuous network region and a plurality of fibrous pillows outwardly extending from the network region, a density of the network region being greater than a density of the fibrous pillows, The individual areas of the pseudo-apertures are at least 10 times, more specifically at least 50 times, and even more specifically at least 100 times, larger than individual areas of the discrete fibrous pillows. In another embodiment, each of the plurality of relatively high-density regions and the plurality of intermediate-density regions comprises a substantially semi-continuous patter. Portions of the fibrous structure surrounding the pseudo-apertures can comprise the substantially continuous network region and a plurality of fibrous pillows extending therefrom, and/or a substantially semi-continuous pattern of the relatively high-density and intermediate-density regions.

In one aspect of the present invention, the pseudo-apertured fibrous structure can comprise a plurality of relatively high-density regions, a plurality of relatively low-density regions, and a plurality of intermediate-density regions. The plurality of relatively low-density regions can comprise a plurality of discrete pseudo-apertures. The plurality of relatively high-density regions and the plurality of intermediate-density regions in combination form a first, or “micro-”, pattern, and the plurality of pseudo-apertures form a second, or “macro-”, pattern superimposed with the first pattern to form an integrated, or combined, pattern.

A process for making a single-ply fibrous structure of the present invention comprises the steps of: (a) providing a fluid-permeable molding member comprising a framework which most typically can be joined to a reinforcing element and extend from the reinforcing element to form a web-side of the molding member, wherein the framework has a first plurality of deflection conduits extending through the framework and comprising a first, or micro-, pattern, and a second plurality of discrete deflection conduits extending through the framework and comprising a second, or macro-, pattern; (b) providing a plurality of fibers; (c) depositing the plurality of fibers to the website of the molding member; (d) deflecting a first plurality of fibers into the first plurality of deflection conduits thereby forming a plurality of fibrous pillows therein; and (e) deflecting a second plurality of fibers into the second plurality of deflection conduits thereby forming a plurality of pseudo-apertures. Individual areas of the second plurality of deflection conduits are at least about 3 square millimeters. The first and second patterns of the deflection conduits are mutually superimposed in the framework to form an integrated, combined, pattern The steps of deflecting the first and second pluralities of selected portions of fibers into the first and second pluralities of deflection conduits, respectively, can comprise applying a fluid pressure differential, and more specifically a vacuum pressure, to the plurality of fibers disposed on the web-side of the molding member.

In one embodiment, the process according to the present invention further comprises steps of providing a flexible sheet of material and overlaying the web disposed on the molding member with the flexible sheet of material, the flexible sheet of material being structured to deflect under the influence of the fluid pressure differential.

In another aspect of the present invention, the pseudo-apertured fibrous structure can be made by a process comprising the following steps: (a) providing a fluid-permeable forming member comprising a plurality of protuberances; (b) providing a plurality of fibers; (c) depositing the plurality of fibers to the forming member thereby forming a fibrous web thereon such that the plurality of discrete protuberances form the plurality of apertures in the web; (d) providing a fluid-permeable molding member having a plurality of deflection conduits therein; (e) transferring the web from the forming member to the molding member; (f) applying a fluid pressure differential to the web to (i) deflect selected portions of the web into the plurality of deflection conduits of the molding member, thereby forming a plurality of fibrous pillows therein, and (ii) cause individual fibers disposed at periphery of the apertures to at least partially extend into the areas of the apertures, thereby forming the pseudo-apertures having the basis weight from about 0.1 to about 5 gram per square meter. The process can further comprise the steps of providing a pressing surface and pressing the web disposed on the molding member against the pressing surface to densify portions of the web that are disposed on the web-side of the molding member's framework. The forming member comprises a first reinforcing element disposed at a first elevation. The plurality of discrete protuberances is joined to the first reinforcing element and extends therefrom to form a second elevation (which may or may not be uniform). Individual areas of the protuberances at the first elevation are at least about 3 square millimeters and can have a major axis and a minor axis perpendicular to the major axis. The major axis is from about 1 to about 100, and more specifically from about 5 to about 50, times greater than the minor axis. The individual areas of the deflection conduits of the first (micro-pattern) plurality are at least 10 times, more specifically at least 50 times, and even more specifically at least 100 times, smaller than individual areas of protuberances at the first elevation.

The molding member comprises a framework having a web-side and a backside opposite thereto. The framework can be joined to a second reinforcing element, in which instance the framework outwardly extends from the second reinforcing element. The framework of the molding member has a first plurality of deflection conduits extending through the framework and comprising a first pattern. The molding member used in the latter aspect of the process also may, but does not need to, have the second plurality of deflection conduits.

The process of the present invention, in either aspect, can further comprise a step of foreshortening the fibrous structure, by creping, wet-microcontraction, or any combination thereof.

### BRIEF DESCRIPTION OF DRAWINGS

FIG. 1 is a schematic plan view of an embodiment of a single-ply fibrous structure of the present invention, comprising an integrated pattern formed by two patterns: (i) a first micro pattern formed by relatively intermediate-density regions and relatively high density regions and (ii) a second macro-pattern formed by a plurality of pseudo-apertures comprising relatively low-density regions.

FIG. 2 is a schematic plan view of another embodiment of a single-ply fibrous structure of the present invention, comprising an integrated pattern formed by two patterns: (i) a first micro-pattern formed by a plurality of substantially semi-continuous intermediate-density regions and high density regions and (ii) a second macro-pattern formed by a plurality of pseudo-apertures comprising relatively low-density regions.

FIG. 3 is a schematic cross-sectional view of the fibrous structure of the present invention.

FIG. 4 is a schematic plan view of an embodiment of a molding member that can be used in making the fibrous structure of the present invention, the molding member comprising a reinforcing element and a substantially continuous framework joined thereto, the framework having a plurality of “angled” (relative to a machine direction) discrete deflection conduits extending therethrough in a non-random and repeating macro-pattern.

FIG. 4A is a schematic cross-sectional view of the molding member shown in FIG. 4 and taken along lines 4A-4A.

FIG. 5 is a schematic plan view of another embodiment of a molding member similar to that shown in FIG. 5, the molding member comprising a reinforcing element and a substantially continuous framework joined thereto, the framework having a first non-random and repeating micro-pattern of a first plurality of discrete deflection conduits extending through the framework and a second non-random and repeating macropattern of a second plurality of discrete deflection conduits extending through the framework.

FIG. 5A is a schematic cross-sectional view of the molding member shown in FIG. 5 and taken along lines 5A-5A.

FIG. 6 is a schematic plan view of an embodiment of a forming member that can be used in making the fibrous structure of the present invention, the forming member comprising a reinforcing element and a plurality of discrete protuberances joined thereto and outwardly extending therefrom to form a non-random and repeating macro-pattern.

FIG. 6A is a schematic cross-sectional view of the forming member shown in FIG. 6 and taken along lines 6A-6A.

FIG. 7 is a schematic cross-sectional view of a process for making the fibrous structure of the present invention.

FIG. 8 is a schematic plan view of a flexible sheet of material that can be used in the process of the present invention.

### DETAILED DESCRIPTION OF THE INVENTION

As used herein, unless otherwise indicated, the following terms have the following meanings.

Fibrous structure is an arrangement comprising cellulosic fibers, synthetic fibers, or any combination thereof that form a thin and macroscopically planar sheet.

Basis weight (of the fibrous structure) is the weight (in grams) per unit area (in square meters) of a sample (of the fibrous structure).

Machine direction (MD) is a direction parallel to the flow of the fibrous structure being made during a manufacturing process, at a particular point thereof. Since the direction of the flow of the fibrous structure can (and most typically does) change during the manufacturing process, the machine direction can also change, depending on a particular point of the process under consideration. Cross-machine direction (CD) is a direction perpendicular to the machine direction and parallel to the general plane of the fibrous structure during the manufacturing process at a particular point thereof.

Pseudo-aperture is a substantially open and low-opacity (to the point of being almost transparent) element of the fibrous structure of the present invention, that may appear to be a hole yet has a minimal number of fibers therewithin. Pseudo-apertures have individual open areas greater than about 3 square millimeters and a basis weight from about 0.1 to about 5.0 gram per square meter. The individual areas of the pseudo-apertures can be measured when the pseudo apertured fibrous structure is placed in a two-dimensional configuration on an X-Y reference plane. The symbols “X-Y” and “Z” designate a conventional three-dimensional Cartesian coordinate system, with X-Y forming the reference plane, and Z being perpendicular to the X-Y plane. The individual areas of the pseudo-apertures can also be approximated based on the relevant elements (such as, for example, the size and shape of deflection conduits and/or protuberances that form the pseudo-apertures) of a molding member used to make the pseudo-apertured fibrous structure, as explained below. The real size of the pseudo-apertures, however, may be different from those of deflection conduits and protuberances, especially if the fibrous structure has been foreshortened. The pseudo-apertures have a high fluid permeability that allows fluids, such as water, to easily pass therethrough, while at the same time retain at least some particles comprising solid matter. Such as contaminants contained in water, within the pseudo-aperture due to a shape of the pseudo-apertures and the existence of fibers within the pseudo-apertures. A pattern of a plurality of pseudo-apertures is referred herein to as a “second pattern” and/or as a “macro-pattern.” A pseudo-apertured fibrous structure (or fibrous structure, or sheet) is a fibrous structure that has pseudo-apertures therein.

The pseudo-apertures of one fibrous structure are said to be “offset” relative to the pseudo-apertures of another fibrous structure when orthogonal (Z) individual projection areas of the pseudo-apertures of the one fibrous structure to the X-Y reference plane and orthogonal (Z) individual projection areas of the pseudo-apertures of the other fibrous structure to the same X-Y reference plane formn common individual areas that are less than about 50% of the smallest one of these individual projections. For example, if the individual areas (and thus their orthogonal projections) of the pseudo-apertures of one fibrous structure are 12 square millimeters and the individual areas (and thus their orthogonal projections) of the pseudo-apertures of the other fibrous structure are 6 square millimeters, the pseudo-apertures of these two plies will be considered “offset” if common individual areas formed by orthogonal projections of both of these plies' pseudo-apertures to the reference plane surface are less than about 3 square millimeters (i. e., less than about half of the smallest, 6-square-millimeter, individual areas of the pseudo-apertures of one of the plies under consideration).

“Macroscopical” or “macroscopically” refers to an overall geometry of a structure under consideration (a web, a molding member, or a forming member) when it is placed in a two-dimensional configuration on the X-Y reference plane. In contrast, “microscopical” or “microscopically” refers to relatively small details of the structure under consideration, without regard to its overall geometry.

“Substantially continuous” element (framework, region, area, surface, etc.) refers to an element (of a molding member or the fibrous structure of the present invention) wherein one can connect any two points on or within the element by an uninterrupted line running entirely on or within that continuous substantially element throughout the line's length. For example, the continuous framework of the molding member has a substantial “continuity” in all directions parallel to the reference X-Y plane and is terminated only at edges of the molding member. The term “substantially” (in conjunction with continuous) means that while an absolute continuity of the element under discussion is preferred (and intended while designing and making the element), minor deviations from the absolute continuity may be tolerable as long as those deviations do not appreciably affect the, performance of the element or a member comprising such element, as designed and intended.

“Substantially semi-continuous” element (framework, region, area, surface. etc.) refers to the element which has “continuity” in all, but at least one, directions parallel to the X-Y plane, and in which element one cannot connect any two points on or within the element by an uninterrupted line running entirely on or within that element throughout the line's length. Of course, the semi-continuous element may have continuity only in one direction parallel to the X-Y plane. By analogy with the continuous pattern described above, while an absolute continuity in all, but at least one, directions is preferred, minor deviations from such continuity may be tolerable as long as those deviations do not appreciably affect the performance of the element under consideration.

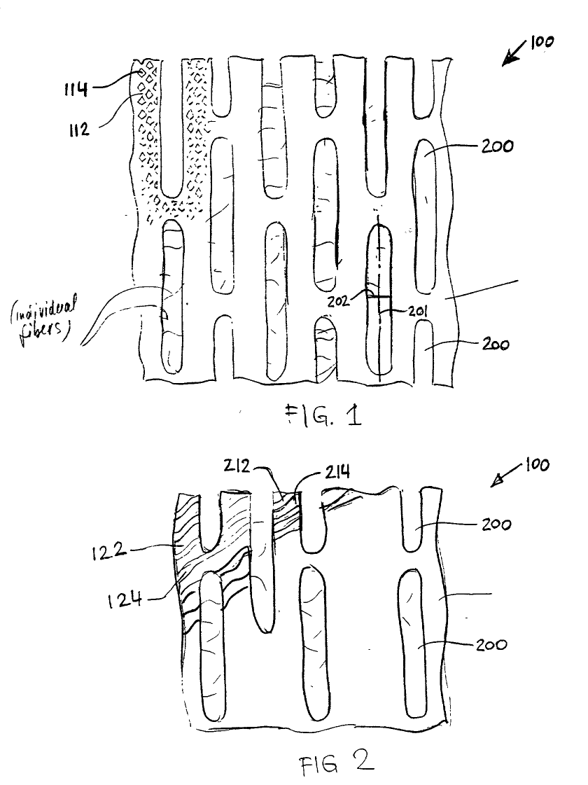

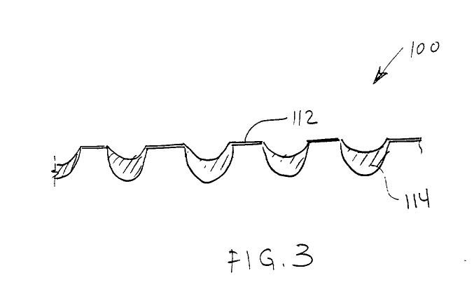

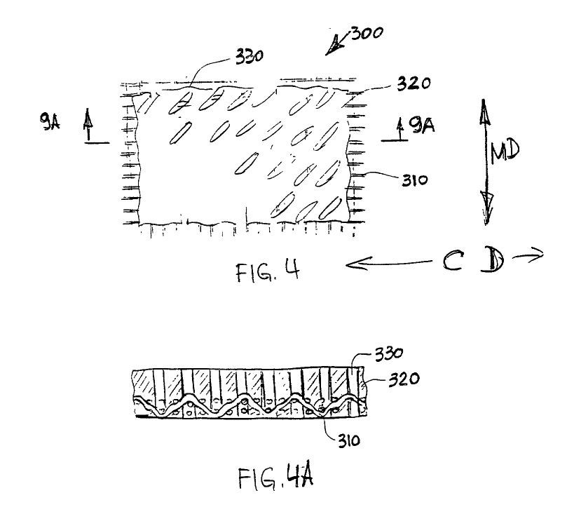

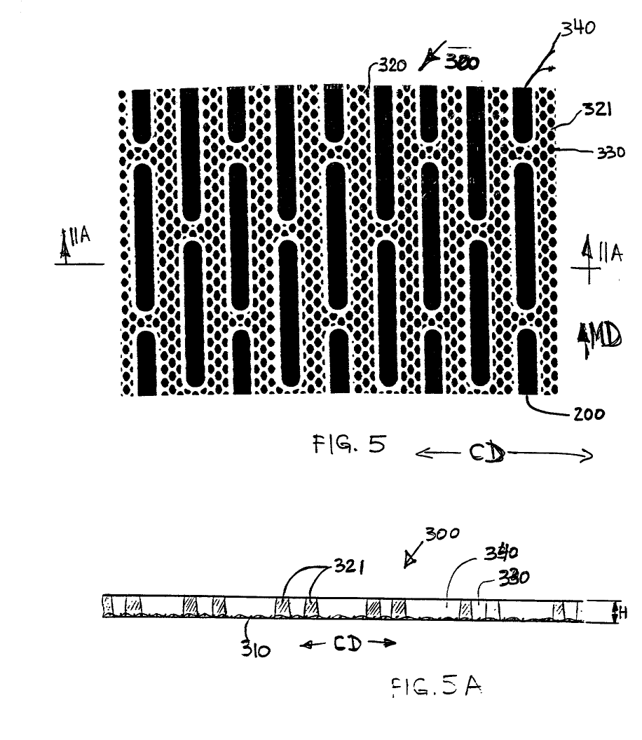

Referring to FIGS. 1 and 2, pseudo-apertures 200 are disposed in the fibrous structure 100 of the present invention in a “macro-pattern,” that can generally be non-random and repeating. This macro-pattern may vary. For example, one portion of the pseudo-apertured structure 100 may have a pattern that is different from that of the other portion of the same pseudo-apertured structure 100. The pseudo-apertures 200 have individual areas of at least about 3 square millimeters, and more specifically at least about 6 square millimeters. A basis weight of the pseudo-apertures 200 is from about 0.1 to about 5 gram per square meter. There are from about 5,000 to about 90,000, and more specifically from about 9,000 to about 35,000 pseudo-apertures 200 per square meter of the pseudo-apertured fibrous structure 100.

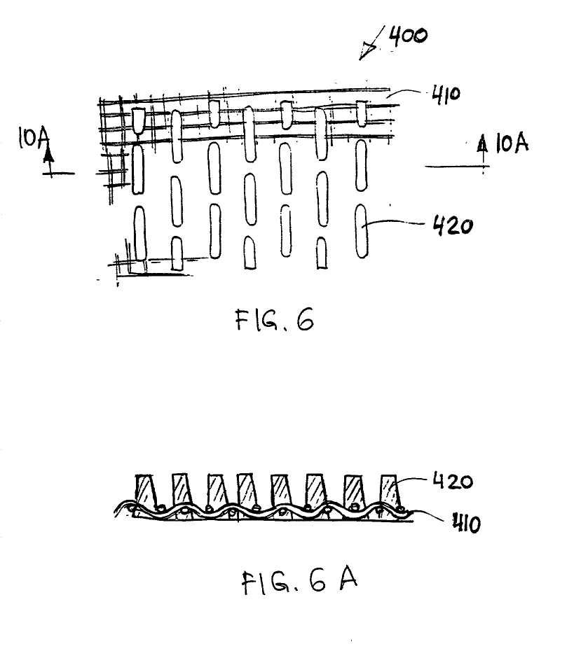

The individual areas of the pseudo-apertures 200, especially those that are regularly shaped, can have a major axis 201 and a minor axis 202 perpendicular to the major axis 201 (FIG. 1). The major axis 201 is from about 1 times to about 100 times, and more specifically from about 5 to about 50 times, greater than the minor axis 202. The pseudo-apertures can be oriented such that their major axes are parallel to the machine direction (FIG. 5), parallel to the cross-machine direction (not shown), or angled relative to the machine or cross-machine directions (FIG. 8).

FIGS. 1-3 show embodiments of the multi-density fibrous structure 100. In the embodiment of FIG. 1, the multi-density fibrous structure 100 comprises a substantially continuous network region 112 and a plurality of fibrous pillows 114 outwardly extending from the network region 112, a density of the network region 112 being greater than a density of the fibrous pillows 114. The individual areas of the pseudo-apertures 200 can be at least 10 times, more specifically at least 50 times, and even more specifically at least 100 times, larger than individual areas of the discrete fibrous pillows of the pseudo-apertured fibrous structure 100. In FIG. 2, the multi-density fibrous structure 100 comprises a substantially semi-continuous network region 122 and a plurality of substantially semi-continuous fibrous pillows 124 outwardly extending from the network region 122, a density of the network region 122 being greater than a density of the fibrous pillows 124.

The pseudo-apertured fibrous structure 100 of the present invention can have three differential-density or basis weight regions. The disclosure of commonly assigned U.S. Pat. No. 5,277,761 (Dean Van Phan et. al, issued January 1994) is incorporated herein by reference. This patent describes a cellulosic fibrous structure, such as paper, that has at least three intensively distinct regions. The regions are distinguished from one another by intensive properties, such as basis weight, density, and projected average pore size, or thickness.

In some embodiments, the pseudo-apertured fibrous structure 100 of the present invention can be viewed as a fibrous structure having relatively high-density regions, relatively low-density regions comprising pseudo-apertures 200, and intermediate-density regions The relatively high-density regions can comprise a substantially continuous network region 112, and the intermediate-density regions can comprise a plurality of discrete fibrous pillows 114 extending outwardly from the network region. A density of the pseudo-apertures 200 can range from about 1 gram per cubic meter to about 20 gram per cubic meter, and more specifically, from about 3 gram per cubic meter to about 10 gram per cubic meter.

Methods of measuring a basis weight and a density of differential regions of fibrous structures are described in detail in the above-referenced commonly-assigned and incorporated herein by reference U.S. Pat. No. 5,277,761, starting at column 15, line 25, under the heading “Analytical Procedures.” Those methods can be applied to measuring the basis weight and the density of the differential regions of the pseudo-apertured plies 100 of the present invention, including the pseudo-apertures 200.

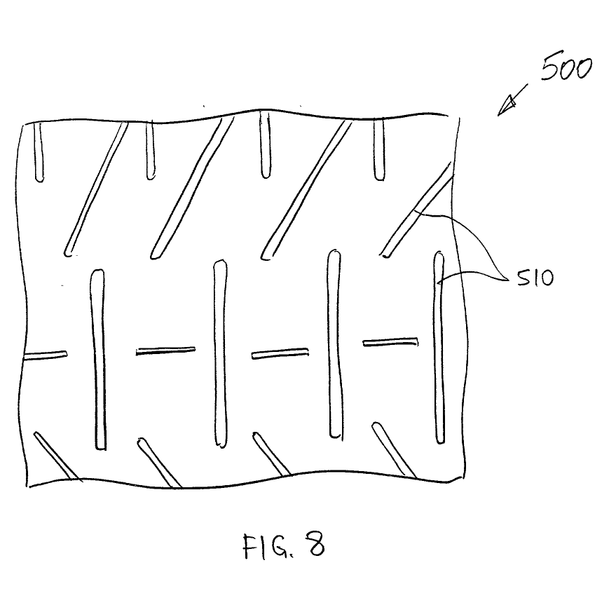

The pseudo-apertured fibrous structure 100 of the present invention can be made by two principally different processes or a combination thereof. In one process, the pseudo-apertures 200 can be formed prior to and independently from the formation of the fibrous pillows. In another process, the pseudo-apertures 200 can be formed simultaneously with the formation of the fibrous pillows. If the pseudo-apertured fibrous structure 100 comprises cellulosic filers, in the former process the pseudo-apertures 200 can be formed in a forming section of a paper machine, while in a latter process the pseudo-apertures 200 can be formed in a pressing section of the paper machine. One skilled in the art would appreciate that generally, the forming section of the paper machine (FIG. 7) is a section where aqueous dispersion of cellulosic fibers is deposited onto a forming member 400 so that water can be drained therefrom and an embryonic web be formed on the forming member 400. From the forming member 400 the embryonic web is transferred to the molding member 300 of the pressing section where the embryonic web can be pressed against a patterned surface of the molding member 300, to be further dewatered and structured.

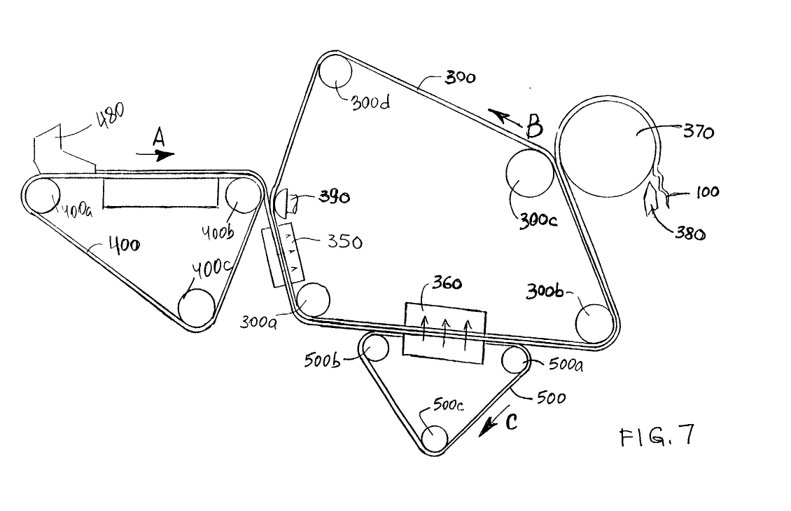

The process wherein the pseudo-apertures 200 are formed in a forming section of a paper machine comprises the following steps: providing a fluid-permeable forming member 400 (FIGS. 6 and 6A) comprising a first reinforcing element 410 and a plurality of protuberances 420 joined thereto and outwardly extending therefrom; providing a plurality of fibers: depositing the plurality of fibers to the forming member 400 thereby forming a fibrous web thereon such that the plurality of discrete protuberances 420 form the plurality of apertures in the web, providing a fluid-permeable molding member 300 comprising a framework 320 having a web-side 320a and comprising a first plurality of deflection conduits 330; transferring the web from the forming member 400 to the molding member 300; applying a fluid pressure differential to the web to (i) deflect selected portions of the web into the first plurality of deflection conduits of the molding member 300, thereby forming a plurality of fibrous pillows therein, and (ii) cause individual fibers disposed at a periphery of the apertures to at least partially extend into the areas of the apertures, thereby forming the pseudo-apertures 200 having the basis weight from about 0.1 to about 5 gram per square meter. The process can further comprise steps of pressing the web disposed on the molding member 300 against a pressing surface, such as, for example, a surface of a Yankee dryer 370, shown in FIG. 13, to densify portions of the web.

The process wherein the pseudo-apertures 200 are formed in a pressing section of a paper machine comprises, additionally or alternatively to the steps of forming section process described in the preceding paragraph, the following steps: providing the fluid-permeable molding member 300 (FIGS. 4-5A) comprising the framework 320, wherein the framework comprises the first plurality of deflection conduits 330 (the “micro-pattern) and a second plurality of deflection conduits 340 (the “macro-pattern”); depositing a plurality of fibers to the web-side 320a of the molding member 300; deflecting a first plurality of fibers into the first plurality of deflection conduits 330 thereby forming a plurality of fibrous pillows therein; and deflecting a second plurality of fibers into the second plurality of deflection conduits 340 thereby forming a plurality of pseudo-apertures 200 in the web.

One skilled in the art will appreciate that both forming section and pressing section processes described above can be combined such that the pseudo-apertures are formed on both the forming member 400 and the molding member 300.

In the forming member 400, the first reinforcing element 410 is disposed at a first elevation, and the plurality of discrete protuberances 420 extends therefrom to form a second elevation. If desired, the plurality of discrete protuberances 420 can comprise a non-random and repeating pattern. The individual areas of the protuberances 420 at the first elevation are at least about 3 square millimeters. The individual areas of the protuberances 420 at the first elevation can have a major axis and a minor axis perpendicular to the major axis (analogously to the major and minor axes of the pseudo-apertures 200 described above), the major axis being from about 1 to about 100, and more specifically from about 5 to about 50, times greater than the minor axis, The individual areas of the deflection conduits of the first (micro-pattern) plurality are at least 10 times more specifically at least 50 times, and even more specifically at least 100 times, smaller than individual areas of protuberances 420 at the first elevation.

The present invention contemplates the use of a variety of fibers, such as, for example. papermaking cellulosic fibers, synthetic fibers, starch fibers, or any other suitable fibers, and any combination thereof. Papermaking fibers useful in the present invention include cellulosic fibers commonly known as wood pulp fibers. Fibers derived from soft woods (gymnosperms or coniferous trees) and hard woods (angiosperms or deciduous trees) are contemplated for use in this invention. The particular species of tree from which the fibers are derived is immaterial. The hardwood and softwood fibers can be blended, or alternatively, can be deposited in layers to provide a stratified web. U.S. Pat. No. 4,300,981 issued Nov. 17, 1991 to Carstens and U.S. Pat. No. 3,994,771 issued Nov. 30, 1976 to Morgan et al. are incorporated herein by reference for the purpose of disclosing layering of hardwood and softwood fibers.

The wood pulp fibers can be produced from the native wood by any convenient pulping process Chemical processes such as sulfite, sulfate (including the Knaft) and soda processes are suitable. Mechanical processes such as thermomechanical (or Asplund) processes are also suitable. In addition, the various semi-chemical and chemi-mechanical processes can be used. Bleached as well as unbleached fibers are contemplated for use. When the fibrous web of this invention is intended for use in absorbent products such as paper towels, bleached northern softwood Kraft pulp fibers may be used. Wood pulps useful herein include chemical pulps such as Kraft, sulfite and sulfate pulps as well as mechanical pulps including for example, ground wood, thermomechanical pulps and Chemi-ThermoMechanical Pulp (CTMP). Pulps derived from both deciduous and coniferous trees can be used.

In addition to the various wood pulp fibers, other cellulosic fibers such as cotton linters, rayon, and bagasse can be used in this invention. Synthetic fibers, such as polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

The paper furnish can comprise a variety of additives, including but not limited to fiber binder materials, such as wet strength binder materials, dry strength binder materials, and chemical softening compositions. Suitable wet strength binders include, but are not limited to, materials such as polyamide-epichlorohydrin resins sold under the trade name of KYMENE™ 557H by Hercules Inc., Wilmingon, Del. Other wet strength binders include: Kymene G3 by Hercules Inc., Wilmington, Del., Cecamide 4949TB by Ceca, and Kenores 1440 by Eka Chemicals. Suitable temporary wet strength binders include but are not limited to synthetic polyacrylates. A suitable temporary wet strength binder is PAREZ™ 750 marketed by American Cyanamid of Stanford, Conn. Suitable dry strength binders include materials such as carboxymethyl cellulose and cationic polymers such as ACCO™ 711. The CYPRO/ACCO family of dry strength materials are available from CYTEC of Kalamazoo, Mich.

If desired, the paper furnish can comprise a debonding agent to inhibit formation of some fiber-to-fiber bonds as the web is dried. The debonding agent in combination with the energy provided to the web by the dry creping process, results in a portion of the web being debulked. In one embodiment, the debonding agent can be applied to fibers forming an intermediate fiber layer positioned between two or more layers. The intermediate layer acts as a debonding layer between outer layers of fibers. The creping energy can therefore debulk a portion of the web along the debonding layer. Suitable debonding agents include chemical softening compositions such as those disclosed in U.S. Pat. No. 5,279,767 issued Jan. 18, 1994 to Phan et al., the disclosure of which is incorporated herein by reference. Suitable biodegradable chemical softening compositions are disclosed in U.S. Pat. No. 5,312,522 issued May 17, 1994 to Phan et al. U.S. Pat Nos. 5,279,767 and 5,312,522, the disclosures of which are incorporated herein by reference. Such chemical softening compositions can be used as debonding agents for inhibiting fiber to fiber bonding in one or more layers of the fibers making up the web. One suitable softener for providing debonding of fibers in one or more layers of fibers forming the web 20 is a papermaking additive comprising DiEster Di (Touch Hardened) Tallow Dimethyl Ammonium Chloride. A suitable softener Is ADOGEN.RTM brand papermaking additive available from Crompton Corporation of Tarrytown, N.Y.

The embryonic web can be typically prepared from an aqueous dispersion of papermaking fibers, though dispersions in liquids other than water can be used. The fibers are dispersed in the carrier liquid to have a consistency of from about 0.1 to about 0.3 percent Alternatively, and without being limited by theory, we believe that the present invention is applicable to moist forming operations where the fibers are dispersed in a carrier liquid to have a consistency less than about 50 percent. In yet another alternative embodiment, and still without being limited by theory, we believe that the present invention can also be applicable to air-laid structures (not shown), including air-laid webs comprising pulp fibers, synthetic fibers, and mixtures thereof.

When the plurality of fibers is deposited to the forming member 400, the protuberances therein form apertures in the embryonic web. Then the embryonic web is transferred to the pressing section, i. e., to the fluid-permeable molding member 300, FIGS. 4-6A. The patterned framework 320 of the molding member 300 may be made from a variety of materials, including but not limited to: resinous material, metal, metal-impregnated resin, plastic, or any combination thereof. The framework 320 has a web-side 320a and a backside 320b.

If the framework 320 of the molding member 300 is made of the resinous material or other material having insufficient inherent strength, or has a pattern that can be distorted when pulled in the machine direction, a second reinforcing element 310 is typically used to enforce the framework 320. Then, the patterned framework 320 can be joined to the second reinforcing element 310. The reinforcing element may be necessary when the patterned framework 320 comprises a semi-continuous pattern or a pattern comprising a plurality of discrete protuberances. Typically, the reinforcing element 310 is positioned between the web-side 320a and at least a portion of the backside 320b of the framework 320. In some embodiments, the reinforcing element 310 may comprise the backside 320b of the framework 320.

The reinforcing element 310, 410 is fluid-permeable and can comprise a woven screen, or an apertured element, a felt, or any combination thereof. Various types of the fluid-permeable reinforcing element are described in several commonly assigned U.S. Patents, for example, U.S. Pat. Nos. 5,275,700 and 5,954,097, the disclosures of which are incorporated herein by reference. The reinforcing element 310 may comprise a felt, also referred to as a “press felt” as is used in conventional papermaking. The framework 320 may be applied to the reinforcing element 310 as taught by commonly assigned U.S. Pat. Nos. 5,549,790, issued Aug. 27, 1996 to Phan; U.S. Pat. No. 5,556,509, issued Sep. 17, 1996 to Trokhan et al; U.S. Pat. No. 5,580,423, issued Dec. 3, 1996 to Ampulski et al.; U.S. Pat. No. 5,609,725, issued Mar. 11, 1997 to Phan; U.S. Pat. No. 5,629,052 issued May 13, 1997 to Trokhan et al.; U.S. Pat. No. 5,637,194, issued Jun. 10, 1997 to Ampulski et al.; U.S. Pat. No. 5,674,663, issued Oct. 7, 1997 to McFarland et al.; U.S. Pat. No. 5,693,187 issued Dec. 2, 1997 to Ampulski et al.; U.S. Pat. No. 5,709,775 issued Jan. 20, 1998 to Trokhan et al., U.S. Pat. No. 5,795,440 issued Aug. 11, 1998 to Ampulski et al., U.S. Pat. No. 5,814,190 issued Sep. 29, 1998 to Phan; U.S. Pat. No. 5,817,377 issued Oct. 6, 1998 to Trokhan et al.; and U.S. Pat. No. 5,846,379 issued Dec. 8, 1998 to Ampulski et al., the disclosures of which are incorporated herein by reference.

If desired, the reinforcing element comprising a Jacquard-weave structure can be utilized. Illustrative belts comprising the Jacquard-weave structure can be found in U.S. Pat. No. 5,429,686 issued Jul. 4, 1995 to Chiu, et al.; U.S. Pat. No. 5,672,248 issued Sep. 30, 1997 to Wendt, et al.; U.S. Pat. No. 5,746,887 issued May 15, 1998 to Wendt, et al.; and U.S. Pat. No. 6,017,417 issued Jan. 25, 2000 to Wendt, et al.; the disclosures of which are incorporated herein by reference for the limited purpose of showing a principal construction of the Jacquard weave that can be used in the reinforcing element.

The patterned framework 320 can be substantially continuous, substantially semi-continuous, comprise a plurality of discrete protuberances, or any combination thereof. The substantially continuous framework 320 is shown in FIGS. 4 and 5 The semi-continuous framework 320 is not shown in the figures per se, but could be easily visualized by one skilled in the art from FIG. 2 showing a fragment of the fibrous structure 100 made on a molding member 300 having a semi-continuous framework 320.

Most typically, the framework 320 is made of a curable resinous material, by selectively (through a mask having a pattern of opaque regions and transparent regions) curing a coating of the resinous material. Several incorporated by reference and commonly assigned U.S. patents referred to above describe processes that can be used to make the molding member 300. Suitable curable resinous materials can be readily selected from the many those commercially available. For example, the curable material may comprise liquid photosensitive resins, such as polymers that can be cured or cross-linked under the influence of a suitable radiation, typically an ultraviolet (UV) light. References containing more information about liquid photosensitive resins include Green et al., “Photocross-linkable Resin Systems,” J. Macro-Sci. Revs. Macro Chem., C21 (2), 187-273 (1981-82); Bayer, “A Review of Ultraviolet Curing Technology,” Tappi Paper Synthetics Conf. Proc., Sep. 25-27, 1978, pp. 167-172; and Schmidle, “Ultraviolet Curable Flexible Coatings,” J. of Coated Fabrics, 8, 10-20 (July, 1978). All the preceding three references are incorporated herein by refcrence. Example of the suitable liquid photosensitive resins are included in the Merigraph series of resins made by MacDermid GRAPHICARTS, Incorporated, of Wilmington, Del.

Commonly assigned patent application Ser. No. 09/346,061, titled “Papermaking Belts Having Patterned Framework With Synclines Therein And Paper Made Therewith,” filed in the name of Trokhan, is incorporated herein by reference. This application discloses a frameworks that is interrupted (on its web-side) and subdivided by synclines. The framework, synclines, and deflection conduits, respectively, impart first, second, and third values of intensive properties to regions of a paper made on these portions of the belt. The value of the intensive property of the regions of the paper corresponding to the synclines is intermediate to those of the paper regions corresponding to the framework and the deflection conduits. For example, if the belt is used as a molding member 300, the density of the fibrous structure regions corresponding to the synclines can be less than the density of the fibrous structure regions corresponding to the framework but greater than the density of the fibrous structure regions corresponding to the deflection conduits; and if the belt is used as a forming member, the basis weight of the fibrous structure regions corresponding to the synclines may be greater than the density of the fibrous structure regions corresponding to the framework but less than the basis weight of the fibrous structure regions corresponding to the deflection conduits.

Conventional papermaking equipment and processes can be used to form the embryonic web on the forming member 400. The association of the embryonic web with the molding member 300 can be accomplished by simple transfer of the web between two moving endless belts and assisted by differential fluid pressure. The fibers may be deflected into the molding member 300 by the application of differential fluid pressure induced by an applied vacuum (for example, by a vacuum apparatus 350). Any technique, such as the use of a Yankee drum dryer 370, can be used to dry the web.

The plurality of fibers can also be supplied in the form of a moistened fibrous web (not shown), which should preferably be in a condition in which portions of the web could be effectively deflected into the deflection conduits of the molding member and the void spaces formed between the suspended portions and the X-Y plane.

In FIG. 7, the embryonic web is transferred from the forming member 400 to the molding member 300 by a vacuum pick-up shoe 390. Alternatively or additionally, a plurality of fibers, or fibrous slurry, can be deposited to the molding member 300 directly (not shown) from a headbox 480 or otherwise. In a continuous process, the forming member 400, in the form of an endless belt, travels (in a direction A) around rolls 400a, 400b, and 400c, and the molding member 300, also in the form of an endless belt, travels about rolls 300a, 300b, 300c, and 300d (in a direction B).

The step of deflecting a first plurality of selected portions of fibers into the first plurality of deflection conduits 330 of the molding member 300 produces a plurality of fibrous pillows in the web. Depending on the process, simultaneously with or immediately before or after deflection of the first plurality of selected portions of fibers into the first plurality of deflection conduits 330, a second plurality of selected portions of fibers can be deflected into the second plurality of deflection conduits 340 of the molding member 300—to form a plurality of pseudo-apertures 200. Depending on the process, mechanical, as well as fluid pressure differential, alone or in combination, can be utilized to deflect a portion of the fibers into the deflection conduits of the molding member 300. For example, in a through-air drying process shown in FIG. 7, a vacuum apparatus 350 applies a fluid pressure differential to the web disposed on the molding member 300, thereby deflecting fibers into the deflection conduits of the molding member 300. The process of deflecting of the fibers into the deflection conduits 330 and/or 340 of the molding member 300 may be continued as another vacuum apparatus 360 applies additional vacuum pressure to even further deflect the fibers into the deflection conduits of the molding member 300.

The step of deflecting the fibers into the deflection conduits of the molding member 300 can be accomplished by using a process disclosed in commonly assigned U.S. Pat. No. 5,893,965, issued in the name of Troklhan et al. on Apr. 13, 1999, the disclosure of which is incorporated herein by reference. According to this process, a web disposed on the molding member 300 is overlaid with a flexible sheet of material 500 such that the web is disposed intermediate the sheet of material 500 and the molding member 300, as schematically shown in FIG. 7. The flexible sheet of material 500 has an air-permeability less than that of the molding member. In one embodiment, the flexible sheet of material 500 is air-impermeable. An application of a fluid pressure differential (from the vacuum apparatus 360) to the flexible sheet of material 500 causes deflection of at least a portion of the flexible sheet of material 500 towards the molding member 300, and under a very high pressure into the deflection conduits of the molding member 300, which facilitates deflection of at least a portion of the fibers into the deflection conduits of the molding member 300.

In the present invention, the sheet of material 500 can have orifices 510 therethrough corresponding to a desired pattern of the pseudo-apertures 200, as shown in FIG. 8. In the process of the present invention, on one hand it is desirable to apply a very high vacuum pressure (relative to a typical papermaking process where creation of pinholes is undesirable) to form pseudo-apertures 200. On the other hand, the application of a very high vacuum pressure can adversely affect the rest of the web by encouraging creation of the pinholes therein. Generally, the higher the pressure the higher the risk that some fibers separate from the fibrous structure and pass through the molding member, thereby creating pinholes in the fibrous structure 100 The fluid-impermeable sheet 500 prevents such an occurrence. At the same time, a high deflection pressure will encourage the fibers to better deflect into the deflection conduits the molding member 300. Thus, the flexible sheet of material 500 that has orifices corresponding to a desired pattern of the pseudo-apertures 200 will allow the desirable formation of the pseudo-apertures 200, while precluding the formation of the undesirable pinholes, in the fibrous structure 100 being formed. In a continuous process of FIG. 7, the flexible sheet of material 500 travels around rolls 500a, 500c, and 500c in a direction C.

The process may further comprise a step of impressing the web against a pressing surface, such as, for example, a surface of a Yankee drying drum 370, thereby densifying portions of the web In FIG. 7, the step of impressing the web against the Yankee drying drum 370 is performed by using a pressure roll 300c. This also typically includes a step of drying the web. Finally, the web associated with the molding member 300 can be separated from the molding member 300.

The process of making the pseudo-apertured fibrous structure 100 can also include a step of foreshortening, which can comprise creping, wet-microcontraction, or any combination thereof. As used herein, foreshortening refers to reduction in length of a dry paper web, resulting from application of energy to the web. Foreshortening by creping can be accomplished by any conventional technique, for example, with the use of a creping blade 380 shown in FIG. 7. Creping is disclosed in commonly-assigned U.S. Pat. No. 4,919,756, issued Apr. 24, 1992 to Sawdai, the disclosure of which is incorporated herein by reference. Typically. during creping, rearrangement of the fibers in the web occurs, accompanied by at least partial disruption of fiber-to-fiber bonds. Alternatively or additionally, foreshortening may be accomplished via wet-microcontraction, as taught in commonly-assigned U.S. Pat. No. 4,440,597, issued Apr. 3, 1984 to Wells et al., the disclosure of which incorporated herein by reference.

What is claimed is:

1. A multi-density fibrous structure comprising a plurality of discrete pseudo-apertures disposed therein, wherein the pseudo-apertures have individual areas of at least about 3 square millimeters and a basis weight from about 0.1 to about 5 gram per square meter.

2. The fibrous structure of claim 1, wherein the pseudo-apertures have the individual areas of at least about 6 square millimeters.

3. The fibrous structure of claim 1, wherein the fibrous structure has from about 5,000 to about 90,000 pseudo-apertures per square meter.

4. The fibrous structure of claim 1, wherein the fibrous structure has from about 9,000 to about 35,000 pseudo-apertures per square meter.

5. The fibrous structure of claim 1, wherein individual areas of the pseudo-apertures have a major axis and a minor axis perpendicular to the major axis, and wherein the major axis is from about 1 times to about 100 times greater than the minor axis.

6. The fibrous structure of claim 1,
wherein the fibrous structure further comprises a substantially continuous network region and a plurality of fibrous pillows outwardly extending from the network region, a density of the network region being greater than a density of the fibrous pillows; and
wherein portions of the fibrous structure surrounding the pseudo-apertures comprise the substantially continuous network region and a plurality of fibrous pillows extending therefrom.

7. A fibrous structure comprising a plurality of relatively high-density regions, a plurality of relatively low-density regions, and a plurality of intermediate-density regions,
wherein the plurality of relatively low-density regions comprises a plurality of discrete pseudo-apertures having individual areas of at least about 3 square millimeters and a basis weight from about 0.1 to about 5 gram per square meter, and
wherein the plurality of relatively high-density regions and the plurality of intermediate-density regions in combination form a first pattern, and the plurality of pseudo-apertures form a second pattern superimposed with the first pattern.

8. The fibrous structure of claim 7, wherein the plurality of relatively high-density regions comprises a substantially continuous network area and the plurality of intermediate-density regions comprises a plurality of discrete fibrous pillows outwardly extending from the network area.

9. The fibrous structure of claim 8, wherein the individual areas of the pseudo-apertures are at least 10 times larger than individual areas of the discrete fibrous pillows.

10. The fibrous structure of claim 7, wherein each of the plurality of relatively high-density regions and the plurality of intermediate-density regions comprises a substantially semi-continuous pattern.

11. A process for making a fibrous structure comprising a plurality of discrete pseudo-apertures, the process comprising steps of:
(a) providing a fluid-permeable molding member comprising a reinforcing element and a framework joined thereto and extending therefrom to form a web-side of the molding member, the framework having a first plurality of deflection conduits extending through the framework and comprising a first pattern, and a second plurality of discrete deflection conduits extending through the framework and comprising a second pattern, wherein individual areas of the second plurality of deflection conduits are at least about 3 square millimeters, and wherein the first and second patterns are mutually superimposed;
(b) providing a plurality of fibers;
(c) depositing the plurality of fibers to the web-contacting side of the molding member;
(d) deflecting a first plurality of selected portions of fibers into the first plurality of deflection conduits thereby forming a plurality of fibrous pillows therein: and
(e) deflecting a second plurality of selected portions of fibers into the second plurality of deflection conduits thereby forming a plurality of pseudo-apertures having the basis weight from about 0.1 to about 5 gram per square meter.

12. The process of claim 11, wherein the steps of deflecting the first and second pluralities of selected portions of fibers into the first and second pluralities of deflection conduits, respectively, comprise applying a fluid pressure differential to the plurality of fibers disposed on the web-side of the molding member.

13. The process of claim 12, wherein the steps of deflecting the first and second pluralities of selected portions of fibers into the fist and second pluralities of deflection conduits, respectively, comprise applying a vacuum pressure to the plurality of fibers disposed on the web-side of the molding member.

14. The process of claim 12, further comprising steps of providing a flexible sheet of material and overlaying the web disposed on the molding member with the flexible sheet of material, the flexible sheet of material being structured to deflect under the influence of the fluid pressure differential.

15. The process of claim 11, wherein in the step of providing a fluid-permeable molding member, the framework is substantially continuous and the first plurality of deflection conduits comprises discrete deflection conduits dispersed throughout and encompassed by the framework.

16. The process of claim 11, wherein in the step of providing a fluid-permeable molding member, the framework is substantially semicontinuous and the first plurality of deflection conduits comprises substantially semi-continuous deflection conduits.

17. The process of claim 11, further comprising a step of foreshortening the fibrous structure, wherein the step of foreshortening comprises creping, wet-microcontraction, or any combination thereof.

18. A process for making a fibrous structure comprising a plurality of discrete pseudo-apertures disposed therein, the process comprising steps of:
(a) providing a fluid-permeable forming member comprising a first reinforcing element disposed at a first elevation, and a plurality of discrete protuberances joined thereto and extending therefrom to form a second elevation, wherein individual areas of the protuberances at the first elevation are at least about 3 square millimeters;
(b) providing a plurality of fibers;
(c) depositing the plurality of fibers to the forming member thereby forming a fibrous web thereon such that the plurality of discrete protuberances form the plurality of apertures in the web;
(d) providing a fluid-permeable molding, member comprising a second reinforcing element and a framework joined thereto and extending therefrom to form a web-site of the framework, the framework having a plurality of deflection conduits extending through the framework and comprising a first pattern, wherein individual areas of the deflection conduits are at least 10 times smaller than individual areas of protuberances at the first elevation;
(e) transferring the web from the forming member to the molding member;
(f) applying a fluid pressure differential to the web to
(i) deflect selected portions of the web into the plurality of deflection conduits of the molding member, thereby forming a plurality of fibrous pillows therein, and
(ii) cause individual fibers disposed at periphery of the apertures to extend into the areas of the apertures, thereby forming the pseudo-apertures having the basis weight from about 0.1 to about 5 gram per square meter;
(g) providing a pressing surface;
(h) pressing the web disposed on the molding member against the pressing surface to density those portions of the web that are disposed on the web-site of the framework.

19. The process of claim 18, further comprising a step of foreshortening the web.

20. The process of claim 18, wherein in the step of providing a fluid-permeable forming member, the individual areas of the protuberances at the first elevation have a major axis and a minor axis perpendicular to the major axis, and wherein the major axis is from about 5 times to about 50 times greater than the minor axis.
